(19) United States
(12) Patent Application Publication
(10) Pub. No.: US 2013/0272091 A1
(43) Pub. Date: Oct. 17, 2013

(54) LAND SEISMIC SENSOR FOR MEASURING A PRESSURE WAVEFIELD

(71) Applicant: Oz YILMAZ, Istanbul (TR)

(72) Inventor: Oz YILMAZ, Istanbul (TR)

(21) Appl. No.: 13/848,727

(22) Filed: Mar. 21, 2013

Related U.S. Application Data
(60) Provisional application No. 61/613,817, filed on Mar. 21, 2012.

(51) Int. Cl. G01V 1/18; G01V 1/16

(52) U.S. Cl. CPC G01V 1/186; G01V 1/166
USPC 367/77; 367/171; 367/76; 367/37

(57) ABSTRACT

A seismic sensor unit includes a sensor housing including an inner chamber and a receiver extension for ground coupling, a suspension fluid disposed in the inner chamber, and a hydrophone suspended in the suspension fluid. The seismic sensor unit may include a sensor housing including a steel spike coupled to the ground, a fluid chamber in the sensor housing, a fluid in the fluid chamber, and a hydrophone disposed in the fluid chamber and contacting the fluid such as to detect a pressure wavefield in the fluid caused by ground motion acting on the steel spike. A method includes receiving ground motion at a seismic sensor unit coupled to the ground, transmitting the ground motion to a fluid chamber, creating a pressure wavefield in a fluid in the fluid chamber in response to the ground motion, and detecting the pressure wavefield in the fluid using a hydrophone.

### CROSS-REFERENCE TO RELATED APPLICATIONS

The present application is a non-provisional application claiming priority to U.S. Provisional Patent Application Ser. No. 61/613,817, filed on Mar. 21, 2012, entitled “Land Seismic Sensor For Measuring A Pressure Wavefield,” which is incorporated by reference herein in its entirety.

### STATEMENT REGARDING FEDERALLY SPONSORED RESEARCH OR DEVELOPMENT

Not applicable.

### BACKGROUND

This disclosure relates to seismic exploration for oil and gas, both on land and based in water or marine environments.

A geophone is a device used in land or surface seismic acquisition, both onshore and on the seabed offshore. A geophone detects ground velocity produced by seismic waves and transforms the motion into electrical impulses. Geophones detect motion in only one direction. Conventional seismic surveys on land use one geophone per receiver location to detect motion in the vertical direction. Three mutually orthogonal geophones are typically used in combination to collect three-component seismic data.

Hydrophones, unlike geophones, detect changes in pressure rather than motion. A hydrophone is a device designed for use in detecting seismic energy in the form of pressure changes under water during marine seismic acquisition. Hydrophones are combined to form streamers that are towed by seismic vessels or deployed in a borehole.

During land seismic surveys for engineering and oil and gas applications, a vertical geophone is deployed to measure the vertical component of the velocity of the particle motion as shown in FIG. 1. A geophone comprises a spring-mounted magnetic mass moving within a wire coil to convert the ground motion to an electrical signal. The ground motion is transmitted to the geophone by a steel spike mounted underneath the geophone case. Whereas, a hydrophone, which is normally used in marine seismic surveys, measures the pressure wavefield within the water layer.

### BRIEF DESCRIPTION OF THE DRAWINGS

FIG. 1 is a graph showing a field record of the vertical component of the velocity of particle motion as recorded by a vertical geophone;

FIG. 2 is a graph showing a field record of the vertical component of the velocity of particle motion as recorded by a hydrogeophone according to the principles disclosed herein;

FIG. 3 is a perspective, partial schematic view of a hydrogeophone sensor unit in accordance with principles disclosed herein;

FIG. 4 is a cross-section view of the hydrogeophone sensor unit of FIG. 3;

FIG. 5 is a graph showing the resulting seismic wavefield as recorded by the vertical geophone referenced with respect to FIG. 1; and

FIG. 6 is a graph showing the resulting seismic wavefield as recorded by the hydrogeophone of FIGS. 3 and 4.

### DETAILED DESCRIPTION

The following discussion is directed to various embodiments of the disclosure. The embodiments disclosed should not be interpreted or otherwise used as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment. It is to be fully recognized that the various aspects of the embodiments discussed below may be employed separately or in any suitable combination to produce desired results.

Certain terms are used in the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in the interest of clarity and conciseness. In addition, like or identical reference numerals may be used to identify common or similar elements. For clarity, each instance of a feature or a component may not be identified with reference numerals if another instance is identified elsewhere.

In this disclosure and in the claims the following terms will be used as defined here. The terms “including” and “comprising” are used in an open-ended fashion, and thus should be interpreted to mean “including, but not limited to . . . ”. Unless otherwise specified, any use of any form of the terms “connect”, “engage”, “couple”, “attach”, or any other term describing an interaction between elements is not meant to limit the interaction to direct interaction between the elements and may also include indirect interaction between the elements described. In addition, if the connection transfers electrical power or signals, whether analog or digital, the coupling may comprise wires or a mode of wireless electromagnetic transmission, for example, radio frequency, microwave, optical, or another mode. So too, the coupling may comprise a magnetic coupling or any other known mode of transfer, or the coupling may comprise a combination of any of these modes. As used herein, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to the axis, and a radial distance means a distance measured perpendicular to the axis.

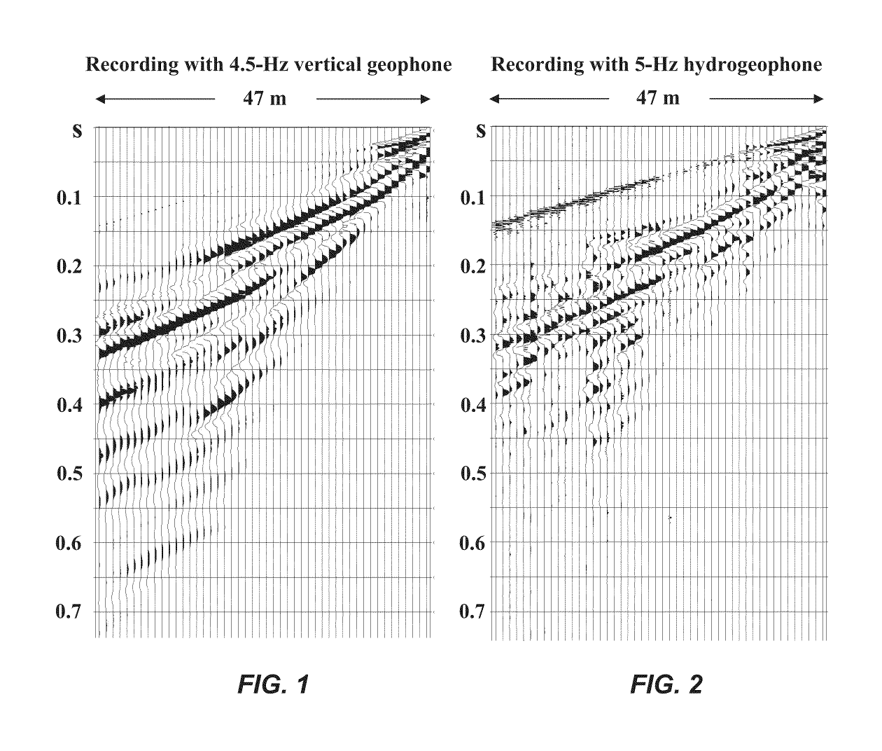

The present disclosure describes embodiments of a surface or land seismic sensor that measures a pressure wavefield. The sensor may also be referred to as a “hydrogeophone.” In an embodiment of the hydrogeophone, the magnetic mass of a geophone and its associated wire coil are replaced with a hydrophone and preamplifier. The hydrophone and preamplifier are both immersed in a liquid with low viscosity within the sensor's case. The hydrogeophone thus measures the pressure wavefield associated with the ground motion as shown in FIG. 2. The field records shown in FIGS. 1 and 2 are displayed with the source-receiver offset in the horizontal axis and recording time in the vertical axis.

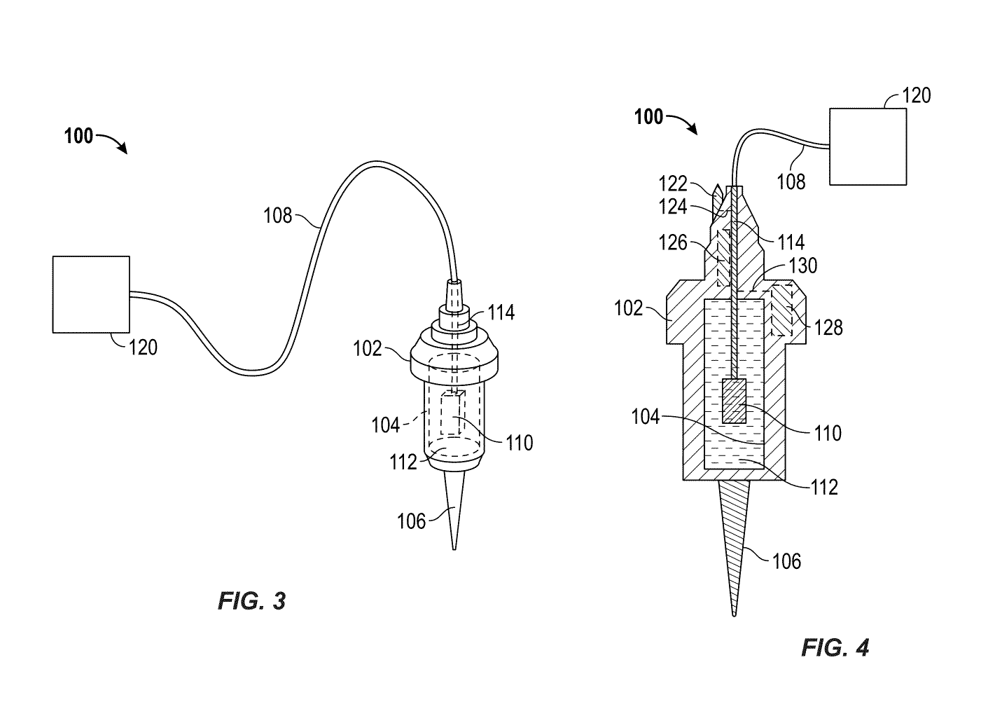

In an embodiment of the hydrogeophone or sensor unit, and with reference to FIG. 3, the sensor unit 100 includes a housing or case 102 having an inner chamber 104 and a communicator or receiver extension 106. In some embodiments, the receiver extension 106 is a steel spike that can be coupled or plugged into the ground. A cable 108 is coupled to the sensor unit 100 for transmitting electrical signals and power between the sensor unit 100 and a recording unit 120 or other seismic survey component. In some embodiments, the seismic survey component may be a controller, processor, computer, or other electronic system capable of communicating with the sensor unit 100 through the cable 108. The inner chamber 104 contains a hydrophone and preamplifier assembly 110 immersed and floating in a suspension fluid 112. A cable or line 114 couples the hydrophone and preamplifier assembly 110 to the cable 108. In exemplary embodiments, the hydrophone assembly 110 is suspended in various locations in the fluid chamber 104.

In some embodiments, the current required by the preamplifier in the hydrophone and preamplifier assembly 110 can be supplied by a 12 volt battery either remotely or locally. In the former embodiment (i.e., remote power), the hydrogeophone 100 is connected to the receiver cable 108 which is then connected to a recording unit 120 with a 12-V power supply. In the latter case (i.e., local power), the hydrogeophone 100 is deployed as a wireless unit with its own battery or other power source. For example, and with reference to FIG. 4, the cable 108 is optionally replaced with a wireless communicator, transmitter, or transceiver 122 electrically coupled to the line 114 at a connection 124. Further, the housing 102 may include one or more batteries 126, 128. The battery 126 electrically couples to the line 114. The battery 128 includes an electrical line 130 coupling to the line 114.

In some embodiments, the hydrophone of the hydrophone and preamplifier assembly 110 includes a frequency response down to 5 Hz. In some embodiments, the preamplifier of the hydrophone and preamplifier assembly 110 includes a type having a minimum 36 dB response. In some embodiments, the suspension or immersion fluid 112 in the chamber 104 includes a low-viscosity mineral oil of any type. In some embodiments, the hydrophone and preamplifier assembly 110 is suspended freely inside the fluid chamber 104.

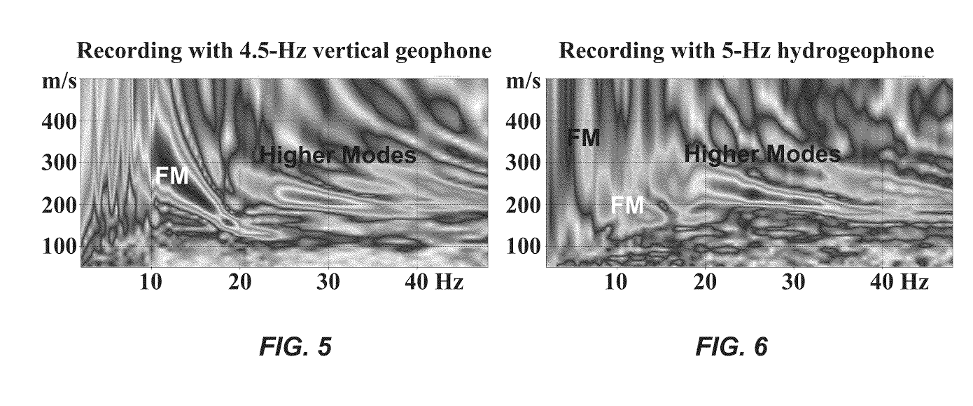

In some embodiments, a field experiment to demonstrate the deployment of the hydrogeophone 100 includes placing a receiver cable along a straight-line traverse on a flat ground. A total of 48 geophones, for example, can be connected to the receiver cable at one meter intervals along the straight-line line traverse. Then, the receiver cable can be connected to a recording system. Next, an aluminum plate is placed on the ground one meter away from one end of the straight-line cable traverse and a vertical impact force is applied to the plate, for example by using a hand-held nine kilogram hammer as an active seismic source. The resulting wavefield is recorded and can be displayed as shown in FIG. 5.

Next, the geophones are replaced with a plurality of the hydrogeophones 100 and the experiment is repeated. The resulting seismic wavefield can be recorded and displayed as shown in FIG. 6.

The recorded data of the geophone and the hydrogeophone 100 can be analyzed to examine the difference between the corresponding recorded wavefields. Dispersion spectra can be used, as shown in FIGS. 5 and 6. The field records shown in FIGS. 1 and 2 are first decomposed to plane-wave components by a coordinate transformation from source-receiver-offset-time coordinates to ray-parameter-linear-moveout-time coordinates. Next, the transformed data are Fourier transformed along the time axis to compute the dispersion spectra shown in FIGS. 5 and 6. In the dispersion spectra, the vertical axis represents the phase velocity of Rayleigh-type surface waves—the inverse of the ray parameter. The dispersion spectrum shown in FIG. 5 associated with the geophone record exhibits a strong fundamental-mode energy (FM), whereas the dispersion spectrum shown in FIG. 6 associated with the hydrogeophone 100 record exhibits a weak, almost absent, fundamental-mode energy. This means that much of the fundamental-mode energy is associated with the SV component of Rayleigh waves. The presence of the higher-mode energy in the hydrogeophone data indicates that much of the higher-mode energy is associated with the P component of Rayleigh waves.

In various embodiments, the hydrogeophone or seismic sensor unit 100 includes a sensor housing 102 including an inner chamber 104 and a receiver extension 106 for ground coupling, a suspension fluid 112 disposed in the inner chamber, and a hydrophone 110 suspended in the suspension fluid. The hydrophone may be part of an assembly including a preamplifer coupled to the hydrophone. The hydrogeophone may include a cable 108, 114 coupled to the sensor housing and the hydrophone. The hydrogeophone may include a remote power supply, such as one located at the recording unit 120, to power the preamplifier through the cable. The hydrogeophone may include a local power supply 126, 128 mounted in the sensor housing and a wireless communicator 122 mounted on the sensor housing. The receiver extension may be configured to receive motion in the ground, and the hydrophone may be configured to detect a pressure wavefield in the suspension fluid caused by the received ground motion. The hydrophone may be configured to measure a pressure wavefield in the suspension fluid associated with ground motion. The suspension fluid may be a low-viscosity mineral oil.

In some embodiments, the hydrogeophone includes a sensor housing including a steel spike coupled to the ground, a fluid chamber in the sensor housing, a fluid in the fluid chamber, and a hydrophone disposed in the fluid chamber and contacting the fluid such as to detect a pressure wavefield in the fluid caused by ground motion acting on the steel spike. The fluid may be a suspension fluid and the hydrophone may be immersed in and suspended in the suspension fluid. The hydrogeophone may include an electrical line coupled between the hydrophone and either a wireless communicator mounted on the sensor housing or a recording unit. The electrical line may couple to a remote power supply or a local power supply mounted in the sensor housing.

In operation, the hydrogeophones described herein can enable a method for seismic data acquisition including receiving ground motion at a receiver extension coupled to the ground, transmitting the ground motion from the receiver extension to a fluid chamber in the hydrogeophone, creating a pressure wavefield in a fluid contained in the fluid chamber in response to the ground motion, and detecting the pressure wavefield in the fluid using a hydrophone. The method may include suspending the hydrophone in the fluid. The method may include displaying seismic data in response to detecting the pressure wavefield. For example, the recording unit 120, or the computer or other electronic systems referred to herein, can display seismic data such as that shown in FIGS. 2 and 6. The method may include supplying power to the hydrophone through an electrical line coupled to a remote power source, and transmitting the seismic data through the electrical line. The method may include supplying power to the hydrophone from a local power source mounted in the sensor unit, and transmitting the seismic data from a wireless communicator mounted on the sensor unit.

Therefore, while disclosed embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. Accordingly, the scope of protection is not limited to the embodiments described herein, but is only limited by the claims that follow, the scope of which shall include all equivalents of the subject matter of the claims.

What is claimed is:

1. A seismic sensor unit comprising:
a sensor housing including an inner chamber and a receiver extension for ground coupling;
a suspension fluid disposed in the inner chamber; and
a hydrophone suspended in the suspension fluid.

2. The seismic sensor unit of claim 1 wherein the hydrophone is part of an assembly including a preamplifer coupled to the hydrophone.

3. The seismic sensor unit of claim 2 further comprising a cable coupled to the sensor housing and the hydrophone assembly.

4. The seismic sensor unit of claim 3 further comprising a remote power supply to power the preamplifier through the cable.

5. The seismic sensor unit of claim 1 further comprising a local power supply and a wireless communicator.

6. The seismic sensor unit of claim 1 wherein the receiver extension is configured to receive motion in the ground, and the hydrophone is configured to detect a pressure wavefield in the suspension fluid caused by the received ground motion.

7. The seismic sensor unit of claim 1 wherein the hydrophone is configured to measure a pressure wavefield in the suspension fluid associated with ground motion.

8. The seismic sensor unit of claim 1 wherein the suspension fluid is a low-viscosity mineral oil.

9. A seismic sensor unit comprising:
a sensor housing including a steel spike coupled to the ground;
a fluid chamber in the sensor housing;
a fluid in the fluid chamber; and
a hydrophone disposed in the fluid chamber and contacting the fluid such as to detect a pressure wavefield in the fluid caused by ground motion acting on the steel spike.

10. The seismic sensor unit of claim 9 wherein the fluid is a suspension fluid and the hydrophone is immersed in and suspended in the suspension fluid.

11. The seismic sensor unit of claim 9 further comprising an electrical line coupled between the hydrophone and either a wireless communicator mounted on the sensor housing or a recording unit.

12. The seismic sensor unit of claim 11 wherein the electrical line couples to a remote power supply or a local power supply mounted in the sensor housing.

13. A method for seismic acquisition comprising:
receiving ground motion at a receiver extension of a seismic sensor unit coupled to the ground;
transmitting the ground motion from the receiver extension to a fluid chamber in the seismic sensor unit;
creating a pressure wavefield in a fluid contained in the fluid chamber in response to the ground motion; and
detecting the pressure wavefield in the fluid using a hydrophone.

14. The method of claim 13 further comprising suspending the hydrophone in the fluid.

15. The method of claim 13 further comprising displaying seismic data in response to detecting the pressure wavefield.

16. The method of claim 15 further comprising supplying power to the hydrophone through an electrical line coupled to a remote power source, and transmitting the seismic data through the electrical line.

17. The method of claim 15 further comprising supplying power to the hydrophone from a local power source mounted in the sensor unit, and transmitting the seismic data from a wireless communicator mounted on the sensor unit.
